(19) United States
(12) Patent Application Publication
(10) Pub. No.: US 2002/0169779 A1
(43) Pub. Date: Nov. 14, 2002

(54) Object oriented knowledge base management system

(76) Inventors: Shian-Shyong Tseng, Hsinchu (TW); Chang-Jiun Tsai, Taipei (TW); Yu-Koh Wu, Taipei (TW); Yao-Tsung Lin, Taichung (TW)

Correspondence Address: BACON & THOMAS, PLLC, 4th Floor, 625 Slaters Lane, Alexandria, VA, 22314-1176, US

(21) Appl. No.: 09/852,046

(22) Filed: May 10, 2001

(51) Int. Cl. G06N 5/02

(52) U.S. Cl. 707/100

(57) ABSTRACT

An object oriented knowledge base management system includes a knowledge based management module to coordinate one or more rule based application software programs (e.g., expert systems) through a knowledge based management and application inference. The knowledge based management module coordinates one or more database management modules, which includes one or more drama model format rule bases and one or more databases. A drama model format rule base stores dramas defined under particular drama model formats and provides the access of users to edit inference rules through a uniform format. Each drama comprises a group of inference rules and a group of roles, which function as objects of the inference rules. The inference relations may exist between or among dramas, and inheritance relations may exist between and among roles.

### FIELD OF INVENTION

The present invention relates to an object oriented knowledge base management system, especially to a system base management system wherein contents in a knowledge base are established and managed through the managements of roles of objects, inference rules and facts.

### BACKGROUND OF INVENTION

The “rule base” system is one of the computerized expert systems. The term “expert system” in the computer science pertains to computerized decision making through the imitation of decision-making processes of human experts, whereby the expert system provides inference capabilities similar to that of human experts in solving a problem. The rule base system is a system that stores rules of inference used by human experts in a particular domain knowledge, such that a problem is solved by using the inference rules as stored and an answer or a result may be obtained through such inference. Other technologies belonging to the field of the expert system include the “quasi-neuro system”, the “case inference technology” etc.

In the past, the rule base system has been implemented in many professional fields successfully. These included medical researches, computer aided designs, industrial manufacture and business decision-making supporting systems. Famous rule base systems included the MYCIN system in the medical field in the diagnosis of diseases and the suggestion of therapy; the DENDRAL system in the chemical field to explain the chemical structure of a molecule; the ACE system in the electronic field to sense problems in a telephone network; and the REACTOR system in the engineering field to sense disorders of a nuclear power plan. Other examples included those used in the expert systems in the geological field or in the computer science.

In the conventional rule-based expert systems, “knowledge” is described and stored in the format of “rules”. A rule includes its “antecedents” and “consequences”. The relations between the antecedents and the consequences are “attributes”. When a “fact” is sensed, an inference is operated. In the inference, the fact is first examined to decide whether all supposition conditions in the antecedents are satisfied. If satisfied, inference consequences are generated. Otherwise, other inference rules are used. The tools used in such an expert system to establish the rule bases, such as the CLIPS, the Prolog etc., also follow these concepts. However, knowledge established through these tools and stored in the rule bases are not made “objects” and structures of the knowledge are not well established.

It is thus necessary to provide a modified expert system that is useful in the establishment and the management of knowledge in a variety of professional fields, that provides improved inference and decision-making capabilities and that is useful in providing suggestions in decision makings.

### OBJECTIVES OF INVENTION

The object of this invention is to provide a novel expert system to establish and to manage a knowledge base in a computer system.

Another object of thin invention is to provide a knowledge base management system to establish and to manage knowledge bases in different professional fields.

Another object of this invention is to provide an object oriented knowledge base management system.

Another object of this invention is to provide a knowledge base management system capable of managing knowledge bases in general fields and professional fields.

Another object of this invention is to provide a knowledge management system to manage a large quantity of knowledge in different fields and with different levels of confidentiality.

### SUMMARY OF INVENTION

The present provides an object oriented knowledge base management system. The object oriented knowledge base management system of this invention comprises a knowledge base management module to coordinate one or more rule base application software (e.g., expert systems) through a knowledge base management and application interface, to function as a development tool for application software applicable to the rule base. The knowledge base management module further coordinates one or more database management modules through a database interface.

The database management module of this invention comprises one or more drama model format rule bases and one or more databases. The drama model format rule base, in turn, stores dramas defined under particular drama model formats and provides the access of users to establish, revise and delete inference rules in and from the rule base through a uniformed format.

The database stores information necessary in all related systems. Each drama comprises a group of inference rules and a group of roles, which function as objects of the inference rules.

The knowledge base application software comprises a rule management module to manage inference rules stored in different dramas, an inference management module to accept inputs of facts to actuate inference rules belonging to respective dramas, such that relative inferences may be operated, and a fact management module to manage facts, formats of facts and interrelations among the facts and the formats, as stored in the management system.

In the object oriented knowledge base management system, inference relations may exist between or among dramas and inheritance relations may exist between and among roles. In addition, a coordination drama may further be provided to manage inferences actuated by facts.

The above and other objectives and advantages of this invention may be clearly understood from the detailed description by referring to the following drawings.

BRIEF DESCRIPTION OF DRAWINGS

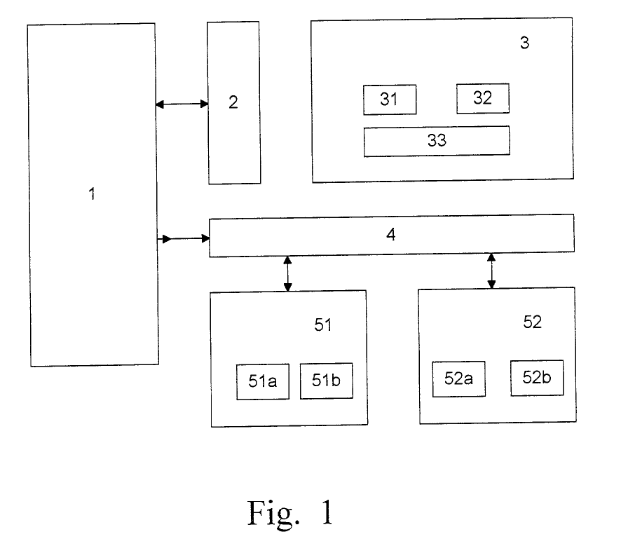

FIG. 1 shows the system diagram of the object oriented knowledge base management system of this invention.

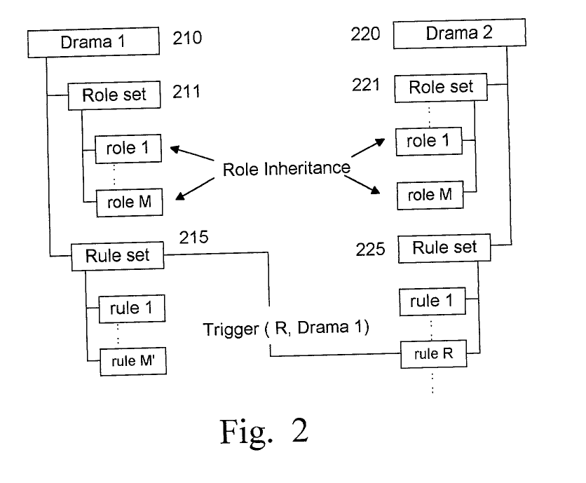

FIG. 2 shows the structure diagram of a drama model format rule base applicable to the object oriented knowledge base management system of this invention.

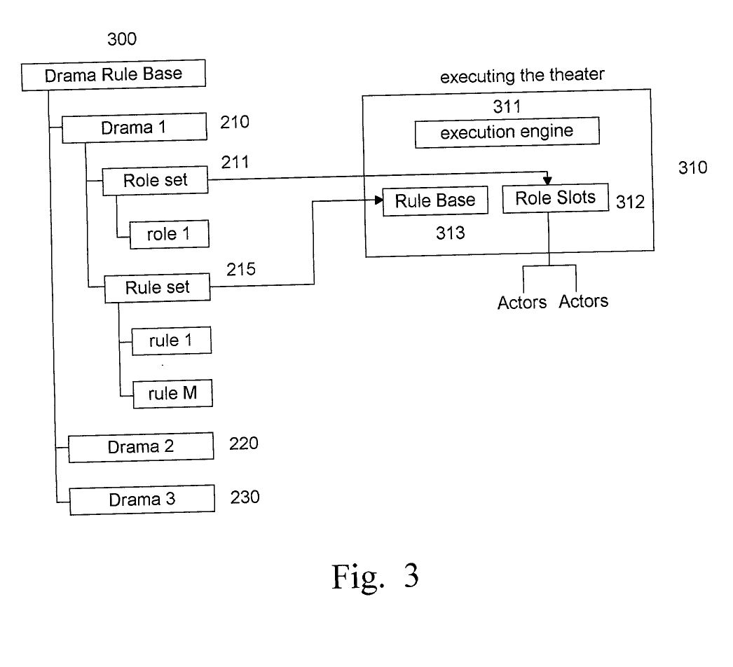

FIG. 3 shows the system diagram of an inference management module of the object oriented knowledge base management system of this invention.

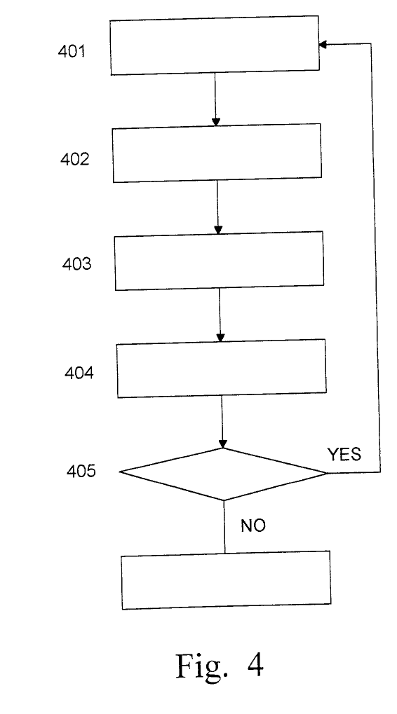

FIG. 4 shows the system flow chart of the object oriented knowledge base management system of this invention.

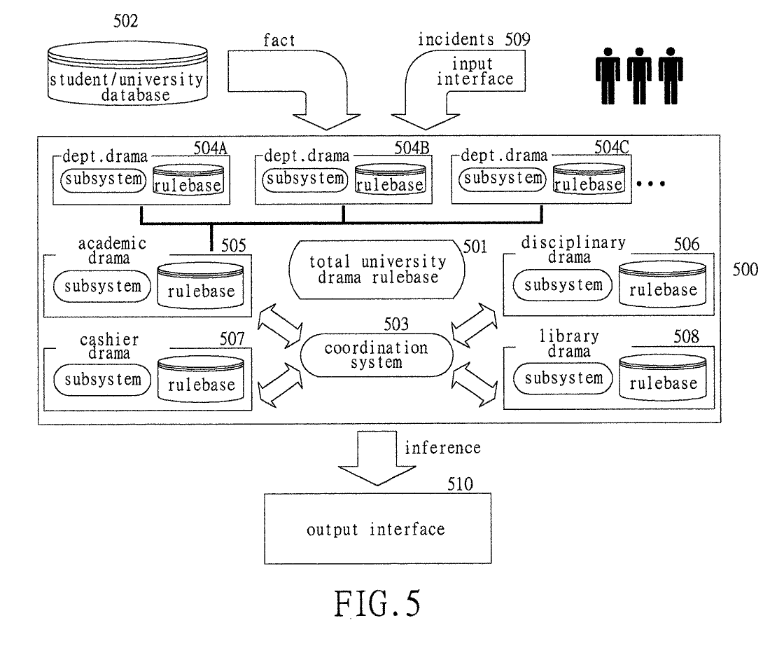

FIG. 5 shows the block diagram of a university management system established by using the object oriented knowledge base management system of this invention.

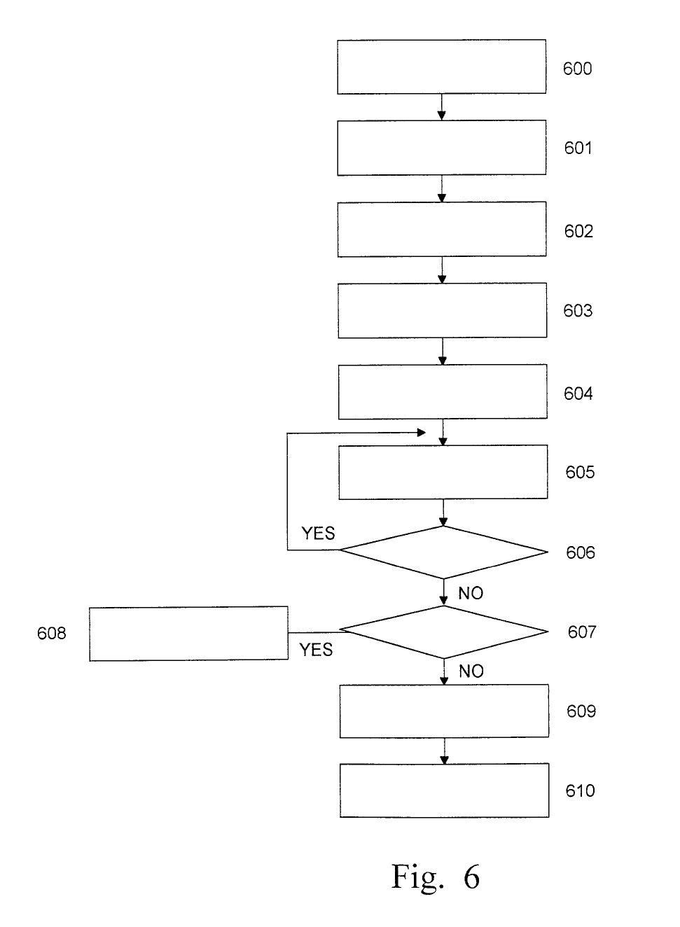

FIG. 6 shows the flow chart of the inference of a librarian fact in the university management system of FIG. 5.

DETAILED DESCRIPTION OF INVENTION

In the object oriented knowledge base management system of this invention, knowledge is also described and stored as rules. The major difference between this invention and the conventional art rests in that knowledge is expressed as objects as well. Such a concept may be analogous to the object oriented technology wherein components of knowledge are attributes and rules. Therefore, the concepts of “data member” and the method of data processing in the object-oriented technology may be applied. The structure of a knowledge base may be established through the inheritance relations between or among objects.

In the invented system, the establishment of the rule base system may be simplified and made easier, in comparison with the conventional art. In establishing the knowledge base, knowledge objects in the general fields may be established first and then knowledge objects in specific fields may be established through the inheritance of attributes from the already established objects. Through such an approach, it is possible to establish a rule base system wherein information may be hidden.

The term “hiding” of information pertains to the approach wherein information and processing of information are encapsulated in objects. Only information that is allowed to be released will be accessible. Other information, on the other hand, is encapsulated by objects. In the object oriented knowledge base management system of this invention, knowledge is encapsulated in knowledge objects. Knowledge so processed will not be damaged when the content of other knowledge objects is changed. In addition, in all knowledge objects, knowledge encapsulated in the same object is that belonging to a particular topic or field. As a result, management of knowledge is made easier than in the conventional art.

As a conclusion, by using the object oriented knowledge base management system of this invention, it is possible to establish a knowledge base management application system that complies with the suited rule base technology. All application systems so developed have the capability to inference and to manage knowledge. The object oriented knowledge base management system of this invention is especially suited for the establishment of knowledge base management application systems inside enterprises. This is partly because that in an enterprise, all departments have their respective rules of operation and decision-making. Under the invented system, every department is able to establish a customized enterprise knowledge base and these knowledge bases are able to comply with rules applied in their upper-leveled departments. Such application may be realized through the inheritance relations between rules in the lower-leveled departments and rules in the upper-level departments. Of course, the object oriented knowledge base management system of this invention is usefull in professional fields, such as therapeutic expert systems, to establish applicable knowledge bases easily and quickly, according to the features of knowledge in the relative fields.

The following is a detailed description of the embodiment of the object oriented knowledge base management system of this invention. FIG. 1 shows the system diagram of the object oriented knowledge base management system of this invention. As shown in this figure, the object oriented knowledge base management system of this invention comprises a knowledge base management module 1 to coordinate one or more rule base application software 3 through a knowledge base management and application interface 2, to function as a development tool for a rule base management application software 3. In the embodiments of this invention, the rule base management application software may be any expert system software. The knowledge base management module 1 further coordinates one or more database management modules 51 and 52 through a database interface 4. In the embodiments of this invention, the database interface may be any interfacing tool such as ODBC API or JDBC API, as used in the conventional art.

The rule base management application software 3 may comprise a rule management module 31, an inference management module 32 and a fact management module 33. The database management modules 51, 52 comprise one or more drama model format rule bases 51a, 52a and/or one or more databases 51b, 52b, respectively.

The functions and operations of the modules will be described in details hereinafter.

The main purpose of the object oriented knowledge base management system of this invention is to provide a development tool for rule base management application software, such as an expert system. In order to achieve the purpose, a function base or API and relative drivers for object oriented knowledge base management systems are provided in this invention. Under the present invention, the application software as developed by using the object oriented knowledge base management system of this invention may further be managed by the function base.

In general, the major functions of a rule base management application software include:

1. Rule management,

2. Inference management, and

3. Fact management.

Accordingly, a rule management module 31, an inference management module 32 and a fact management module 33 are provided in the object oriented knowledge base management system of this invention. In the followings, description of the functions and operations of the object oriented knowledge base management system of this invention will be given based on the respective modules.

1. Rule Management Module 31

The rule management module 31 of this invention allows users to manage model rules through standardized methods, such that the rule base may be shared and reused by all applications. Here, the term “management” pertains to insert, delete and modification of model rules to satisfy particular needs in applications. The model rules are provided in a rule base containing drama model formats.

FIG. 2 shows the structure diagram of a rule base-containing drama model formats applicable to the object oriented knowledge base management system of this invention. As shown in this figure, a knowledge base management application software as established according to the object oriented knowledge base management system of this invention contains a group of dramas. Each drama represents a collection of a group of roles and a group of rules applicable to the roles. Also as shown in FIG. 2, the first drama 210 comprises a role set 211 which contains M roles, Role 1-Role M, and a rule set 215 which contains M′ rules, Rule 1-Rule M′. The second drama 220, in turn, comprises a rule set 221 which contains N roles, Role 1-Role N, and a rule set 225 which contains a plurality of rules. In a knowledge base established under the object oriented knowledge base management system of this invention, a role in one drama may have an inheritance relation with a role belonging to another drama. In other words, the attributes of a role may exist when this same role is also a role in another drama. Among dramas, a rule inference relation may exist. In other words, a rule existing in one drama may actuate or exclude a rule belonging to another drama.

In this invention, the term “role” pertains to objects of rules, i.e., objects operated by rules. In the object-oriented technology, such a role pertains to a set of attributes or factors, stored in the format of data. Each role comprises factors recorded in a predetermined format that is defined by particular templates. The term “rule” pertains to inference rules operable to the roles. Inferences of the roles, i.e., data represented by the roles, are operated according to the conditions and actions (operations) defined by the rules. Sometimes some roles are merely blank slots. For these roles or objects, which are defined as sets of data and role objects, when applicable data, including figures (numbers) and attributes that are required in the system to be developed, are inserted into the blank slots, the roles are thus operable by the relative rules. In other words, when a drama is being operated, the inference rules are operable to the objects or data after they are inserted into the blank slots.

In addition, among different dramas there are inheritance relations. As a result, rules belonging to a parent drama are operable to roles belonging to its children dramas, or are able to actuate the rules of the children dramas.

In order to manage a drama model format rule base as described above, the rule base management module has the following functions and operations:

Definition of Dramas: Defining, e.g., name of drama, names of dramas being inherited, control factors, name of roles and name of rules.

Definition of Roles: Defining, e.g., name of role, names of roles being inherited and control factors.

Definition of Rules: Defining, e.g., name of rule and inference rules. Descriptions of the inference rules are generally in the format of

If<condition>then<action>, in which:

“Conditions” include the format of (fact)operation(fact) and the format of (fact). Each (fact) may be a single fact or a combined fact. In the present invention, description of a single fact may be: (constant), (item) or (identifier). Description of a combined fact, on the other hand, may be a regulation (name of regulation) call or an expression.

“Actions” include the format of an assignment statement, a parent drama call or a procedure call. I.e., under a certain condition, a fact is output (in an assignment statement), the operation is shifted to another drama (in a parent drama call) or an action is actuated (in a procedure call).

Management of Functions: Functions such as insert (addition), revision and deletion of dramas, control factors, roles, and rules are provided.

2. Inference Management Module 32

The major functions of the inference management module 32 include reading out information contents of dramas, including role sets, rule sets etc., from the above-said drama model format rule base, reading out inference materials from relative database, inferring according to applicable inference rules, and saving results of inference into relative database. FIG. 3 shows the system diagram of an inference management module of the object oriented knowledge base management system of this invention. In this figure, components that are the same as in FIG. 2 are labeled with same numbers.

As shown in FIG. 3, a drama set comprises a plurality of dramas 210, 220, 230. Taking the first drama 210 as an example, the first drama 210 comprises a role set 211 and a rule set 215. A rule base management module 310 is provided in the drama base and comprises an executable driver 311, a role base 312 and a rule base 313. Rules and roles of the first drama 210 may be imported by calling the rules and roles from the role base 312 and the rule base 313. The functions of the inference management module 32 also include the generation of a theater stage for a drama and the designation of roles for a drama. When a model drama is called from a drama model format rule base, a drama object is being generated. Such a drama object comprises a role set containing roles to be operated by relative rules and a rule set containing inference rules. Such a drama object may be called a theater stage. Designation of roles applicable in the stage includes selecting applicable inference materials from the database and designation of information contents in a role includes selecting applicable facts in a rule base.

In order to describe the format and content of a drama, an example of dramas in a university administration management system is shown below:

Name of drama: Graduation of a student.

Function of drama: To decide whether a student is allowed to graduate.

Materials: course_(faculties of a university)

Rule: rule_(rules of graduation)

R0: true [rule_.required number of credits for graduation:=rule_reguired number of credits for graduation−course_.number of creditsn acquired]

R1: course_.classification—“general” [rule_.number of credits in general education:=rule_.number of credits in general education−number of credits acquired]

R2: course_.classification=“language” [rule_.number of credits in foreign languages:=rule_.number of credits in foreign languages course_.number of credits acquired]

R3: rule_.required number of credits for graduation<=0 and

rule_.number of credits in general education<=0 and

rule_.number of credits in foreign languages<—0 [rule_.complying with educational regulations:=true]

In the above drama, definitions of the drama include data of role objects and definitions of templates of the roles (1^{st} and 2^{nd} rules) and definitions of rules applicable in this drama. It is obviously shown that the drama is a cell of role object sets and rule sets.

3. Fact Management Module 33

In the object oriented knowledge base management system of this invention, data (facts) to be operated by inference rules include those input by users. As a result, the major functions of the fact management module 33 include formatting of input facts and definition of their relations to the rest of the system. In addition, the fact management module 33 provides a function to decide whether a further inference shall be operated after a fact is input or after an inference has been finished. The content, operation and history of a fact may be recorded by relative application programs. Such recording functions have already been provided in the conventional database or knowledge base application software. Detailed description thereof is thus omitted.

In the structure of the object oriented knowledge base management system of this invention, the fact management module does not only manage the access and formats of data, but also provides a user interface and a function base for the connections of programs, such that new contents may be inserted. Users are able to input necessary values to templates of roles through the user interface and the function base. The user interface may be designed according to features of data or role templates and may be displayed as a table.

4. Management of Templates

In an object oriented knowledge base management application system, templates play an essential part in providing necessary functions. The term “template” pertains to type of a role in the drama. In a template, columns of information elements or components of roles are provided. In the dramas, all roles are generated based on respective templates. Here, a template provides necessary features of a role. Taking the role of “people” as an example, a template for “people” may be given as follows:

PEOPLE[name[string], height[real number], weight[real number]]

Accordingly, in one drama there may be different “people” templates, such as:

Employer(PEOPLE) and

Employee(PEOPLE).

Under such a regulation, every employer and employee has attributes: name, height and weight. Decision-making and inferences may be operated to a role which is an employer or an employee according to the relations among these attributes.

In order to comply with the needs in managing the templates, template managing functions of this invention include:

1. When a drama base is opened, a template file is created. The system will import all templates which are defined as templates belonging to the template file and are stored under particular formats.

2. In the memory of the system, a template may be added (inserted) or deleted according to the request of users.

3. A template may be defined to inherit or multiply inherit to other templates.

The following is a detailed description to the system flow of the operation of the object oriented knowledge base management system of this invention. FIG. 4 shows the system flow chart of the object oriented knowledge base management system of this invention.

As shown in this figure, objects to be operated by the object oriented knowledge base management system of this invention are objects belonging to a drama base. When the system is actuated, at 401 the system requires the user to define a drama. Basically, a drama includes a role set and a rule set. At 402 the user is required to define roles in the drama. As described above, in the invented system, every role is basically a set of data generated on a template. In 403 the user is required to define a template for the roles of the drama In addition, at 404 the user is also asked to designate inference rules for the role. In general, the rules may include: inference rules, logic operation rules, comparison, calculation, and other applicable inference rules. Thereafter, at 405 the system decides whether new dramas shall be defined. If yes, the operation returns to step 401; otherwise, an object oriented knowledge base application system is established.

### Embodiment

In the followings an embodiment of this invention, where a university administration knowledge base is established, is given to show the major functions and operations of the object oriented knowledge base management system of this invention.

Functions

A university administrative knowledge system shall provide necessary functions to the automatic operation of the university administration system. Major functions of such a system include deep-leveled inferences of students' tuition, disciplinary, cashier and librarian activities and of results of such inferences, and managements of disciplinary and accounting data and data regarding students relative to all departments of the university. Such a system also enables students to understand their status in the academic affairs, librarian affairs and cashier affairs. The system shall also provide functions in the management of basic personal information of students and, by incorporating into the system tuition and graduation regulations, the automatic operation of academic affairs.

In a university administration system as described above, the following functions will be provided:

1. InputData

1.1 Basic personal information of students: Including registration number, scores, semester scores, status of admissions, such as faculties, double degree etc., credits finished and additional data such birth date etc.

1.2 Academic information of university: Including faculties, departments etc.

1.3 Academic regulations at the university level: Including basic regulations in the qualification of students and particular regulations in the application of packaged programs etc.

1.4 Disciplinary regulations: Including data regarding students behavior, participation, leaves etc. and regulations applied by the disciplinary departments.

1.5 Cashier regulations: Including data regarding payment from students, scholarship etc. and regulations regarding cashier affairs and registration affairs.

1.6 Librarian regulations: Including data regarding return of borrowed books and regulations regarding the administration of library.

1.7 Tuition information: Including faculties and their classification etc. of respective colleges or departments.

1.8 Tuition regulations at the college or department level: Including all tuition regulations of respective colleges and departments, including required credits and number of credits for graduation.

1.9 Input and revision of facts: Including an interface allowing a staff to input and revise applicable regulations and student information.

2. Output Data

2.1 Results of inference at the department level: Including students' status as inferred according to the personal information of students and applicable department-level regulations.

2.2 Results of inference at the administrative level: Including students' status as inferred according to the personal information of students and applicable administration-level regulations.

2.3 Result of inference at the university level: Including students' status as inferred according to results as inferred from the personal information of students and applicable department level or administrative level regulations, and applicable university level regulations.

3. Search Functions

3.1 Basic personal information of students: Including registration number, name, birth date, scores and credits, status etc.

3.2 Result of inference: Including accomplishments in tuition, double degree, other results of inference in the academic affairs, the disciplinary affairs, the cashier affairs and the librarian affairs.

3.3 Status of students: Including processing and search of students' status in the academic affairs, the disciplinary affairs, the cashier affairs and the librarian affairs.

3.4 Credits or packaged programs to be finished: Including required credits and courses to be finished by a student.

Data Preprocessing

For data processing to which automatic rule inference is not necessary or not possible, a data preprocessing is provided. For example, for credits already finished by a student may be calculated easily by adding all finished credits. These data may be preprocessed and input to the system. Information suited for preprocessing includes:

1. Calculation and input of credits in general knowledge: All students are required to finish a certain number of credits in general knowledge. This calculation is applied to all students.

2. Calculation and input of credits in educational training: For all students allowed to adopt educational training, credits in educational training are calculated and input in the preprocessing.

3. Calculation and input of credits in physical education: Credits in physical education already finished are calculated and input in the preprocessing.

4. Calculation and input of all credits finished: Numbers of credits for old students are calculated and input in the preprocessing. Numbers of credits for new students are 0.

5. Table of finished courses and credits: In the preprocessing, all finished courses and credits listed in a table and stored in the database, such that data in the table may be accessed by applicable application software.

Establishment of Templates

Before any inference may be operated, a list of objects to be operated by relative inference rules and facts shall be provided first. In the object oriented knowledge base management system of this invention, all objects operated by 110 rules and facts are “roles” as defined by and belonging to the dramas. Before the roles may be defined, templates of the roles shall be provided. In the present invention, templates are provided in a drama model format rule base of the rule base management module 31. All facts and roles are defined based on the given templates.

According to this invention, definition of particular roles is made by inputting data and facts into the given templates. These input data and facts may be used as objects of inference rules. As a result, in the establishment of the templates, contents and features of facts (input data) and data columns to be inferred (output data) shall be considered simultaneously. For example, a data file for one student shall include the columns of “score” (input data and facts) and “graduation allowed” (output data). In the score column, data may be input by administrator of the system manually and in the “graduation allowed” column, results of inferences may be input by the system automatically. When the result of an inference shows that the respective student is allowed to graduate, a symbol of “TRUE” will be input to that column.

Possible templates in a university administration knowledge base include:

1. Template in the disciplinary subsystem: The template contains columns such as registration number of student, disciplinary score, records of credits and/or faults etc. Inferences may be operated to these items and the disciplinary office may use results of such inference to order the discontinuation or suspension of a student.

2. Templates in the academic subsystem: The template contains columns including scores, status of registration, finished credits, finished credits in general knowledge etc. Additional data of students such as birth date may also be designed as a column of this template. Specially required attributes, such as required qualifications or authentications, may also be included. The determination of whether required courses are finished may be operated with an application program, by referring to a table of required subjects.

3. Templates in the cashier subsystem: This template contains columns recording payments made by a student. In combination with an intelligent ID card or an electronic money system, automatic payment functions may also be provided.

4. Templates in the librarian subsystem: The template contains columns recording status of return of books. In combination with an automatic delay penalty system, payment collection operations may be actuated accordingly.

5. Templates of facts: The activities of students are expressed by templates of facts. In the present invention, the rule base management module 31 provides the fact template establishment function. Templates of facts are classified into academic facts, disciplinary facts, cashier facts, librarian facts etc. Attribute values of all facts may also be recorded. Each fact is processed by a corresponding rule base or a drama. The role of a fact is similar to that of an alert signal, which requires the system to actuate a proper drama to infer according to the rules of the drama and to output the results of inference. To each drama a Boolean value is provided so that whether a fact is existing and whether necessary process is required, may be determined.

When the templates are established, the templates are stored in the template memory (not shown) of a template management module of the system.

Establishment of Roles

In the object oriented knowledge base management system of this invention, input and output data include results of operations to the roles in the dramas. As a result, all potential input and output data are designated to a corresponding role. The definition of a role shall comply with the definition of its corresponding templates. All roles are results of implementation of such pre-defined templates.

In addition, because all data and facts operated or referenced by the inference rules come from the relative roles, these data are thus stored in the files of the corresponding roles. As a result, source of data shall be identified in the establishment of the roles.

In the embodiment of this invention, the templates shall be able to show the particular department or college to which a student role belongs. Data of attributes of a role, in combination with data of the role relative to all branches of the university, are the content of that role. Function of establishment of roles is also provided in the rule base management module 31. When a role is established, its data are stored in the rule management module 31.

Establishment of Rule Base

In the establishment of the applicable rule base, rules are divided into different levels. In the present embodiment, rules applicable to different offices, departments and colleges are provided in the rule base simultaneously. In the rule base, each component, the rule sets, is used to determine status of students in the aspect of the relative offices, department or colleges. As a result, the rule base may be established by creating rule sets applicable to different dramas, such that the rule base is in a hierarchic structure.

Rule sets applicable to different branches of a university may be in the format that is operable in the relative subsystems. The operation of the rules shall comply with the role objects, as described above.

In the present invention, establishment of the rule bases is one of the functions provided by the rule base management module 31. Rules as established are stored in the drama model format rule base for further use.

Establishment of Dramas

In a university administration knowledge base system, the dramas include a coordination drama to coordinate the operation of the rest dramas, an academic drama operable in the incidents of the academic office, several department dramas operable in the incidents belonging to respective departments, a disciplinary drama operable in the incidents of the disciplinary office, a cashier drama operable in the cashier incidents and a librarian drama operable in the librarian incidents. In addition, a dormitory drama operable to dormitory-related incidents, a restaurant drama operable in the restaurant-related incidents etc. may also be provided, if necessary or applicable. When the dramas are established, the dramas are stored in the drama set for further use.

Coordination Drama

The coordination drama is one of the most important dramas of the system. In the design of this embodiment, all facts are input through this drama. When an incident takes place, a fact is input to the coordination drama of the university administration system and all relative data of the related student(s) are read out from the student/university database and exported into a fact template to be operated by the system. In addition, in the rule base of this drama, the most frequently used inference rule is the decision of whether a corresponding drama or dramas shall be actuated according to the Boolean value of the input fact. For example, the inference rule may be:

If<academic fact>=TRUE, then <actuate academic drama >

If in another drama, facts recorded in the fact template includes a fact defined in the coordination drama, the drama is actuated. At the same time, data of the related elements of the fact template will be transmitted to proper column(s) of the corresponding role(s) of the drama, such that the data becomes objects of relative inferences.

Among the above-said dramas, department dramas inherit features of the academic drama. In principal, all department dramas operate based on the academic drama. When inferences of the academic drama operate to some extent, further inferences are operated in the relative department drama(s). In other words, although particular rule elements and role elements are defined in the dramas of the departments, contents of the academic drama are applied or operated in the department dramas and templates of the academic drama are exported to the relative department dramas and are used as objects of the operations.

Creation of Application Systems

After the preprocessing and the establishment of dramas are completed, a university administration knowledge base application system may be created through the management functions provided by the hierarchic rule base of the invented system. The most important function of such an application system is the inferences of useful information through the functions provided by the coordination drama and the rest dramas. Functions provided by such an application system usually include:

1. Input of incidents/facts to be managed.

2. Formatting and saving incidents/facts into fact roles.

3. Exporting of results of inferences and action thereto.

4. Exporting and saving of facts.

5. Providing management interface for Users.

Example of a University Administration System

A university administration system established according to the object oriented knowledge base management system of this invention is shown in FIG. 5. In the system diagram of FIG. 5, a university administration system 500 comprises a total university drama rule base 501 to manage all dramas and inferences of the university administration system 500; a student/university database 502 to store necessary information for the university administration system 500; a coordination system 503 to coordinate data inputs, outputs and storage of all drama and inferences; a plurality of dramas including department dramas 504A, 504B, 504C, an academic drama 505, a disciplinary drama 506, a cashier drama 507, a librarian drama 508 etc.; each drama comprising a subsystem and a rule base; an input interface 509 to facilitate the insert, delete and revision and manage of data; and an output interface 510 to output all kinds of results of operations.

The functions of the above-said university administration system include:

1. Input of Incidents/Facts

In the university administration system 500 an input interface 509 is provided to enable users to input all kinds of facts. Considering the low repeatability and interrelation between or among facts (e.g., the low possibility of repeating one same incident for one particular student within one day), the input data may be preliminarily stored in a particular buffer memory of the database so that inferences may be operated in the low loading periods, such as at night. Of course, online processing of the inferences is also feasible in the present invention. Here, data of the incidents and facts may be input by users. These data may also be obtained from the student/university database 502.

For most incidents, the operation of the application software is to store the data into the corresponding roles (to be described in detailed hereinafter). However, in order to enhance the efficiency in the decision making of the academic branch of the system, especially the subsystems of the departments and colleges, the course-taking events are processed by having the application program to revise the list of courses and reprocess the preprocessing of the data in the way as described above. As a result, the inference of these data may be easily made.

2. Formatting and Saving Incidents/Facts into Fact Roles

All input incidents/facts, including content of incidents, preprocessed data, personal information of persons involved etc, are converted into acceptable formats by the application program and saved in the column of the roles of the facts. Data stored in the roles become objects of the respective corresponding inferences.

3. Exporting Results of Inferences and Reaction

When a single inference is finished, the personal information as stored in the role relative to the fact will be changed in pursuant to the existence of the fact (incident) and the result of the inference. For example, the existence of a course-taking event may actuate an inference rule to determine whether a student is qualified for graduation. The result of the inference will bring change the Boolean value in the column of “allowed to graduate” in the role to be “TRUE”. In order to conduct the inference, data obtained in the preceding processes shall be taken in combination for consideration. If previously obtained data are not read, the inference will result at nothing.

When results of inferences are read out, an alert will be generated according to applicable inference rules to remind the student or relative branches to take action or other reactions.

4. Exporting and Saving Contents of Facts

Each inference may bring changes to the data of the relative roles or facts. The revised data may be reused, without the need of repeated inferences. For example, if the result of an inference has revealed that a student has finished all required physical education courses, the Boolean value of column “physical education finished” will be recorded in the database. This value may be reused in other operations, without the need to inference again. In order to provide such a function, the application program shall be able to determine and to store reusable data, i.e., some output data of the roles. That is to say, the application program shall be able to read out these data from the columns of the roles in the dramas and to save these data into the external student/university database 407.

5. User Interface

The system has to provide management functions to data regarding students and university, roles, rules and templates of all dramas, such that relative management operations may be easily conducted by an administrator. In the object oriented knowledge base management system of this invention, necessary functions are provided so that the application system so created are capable of providing user interfaces and application programs to facilitate the management of the knowledge base.

Example of Inference Operations

In the followings, an example of a “librarian incident” will be given to describe the operation of a university management system created under the object oriented knowledge base management system of this invention. FIG. 6 shows the flow chart of the processing of a librarian incident.

First, the definition of the “librarian incident” shall be given. In this example, the librarian incident is the fact that a returned book is damaged. This fact is input at 600. At 601 the system reads out title, numbers, price and other attribute of the book from the database and export the data into a column of a role belonging to the librarian drama. At 602, the librarian drama determines the Boolean value of column “existence of a librarian incident” to be “TRUE” and corresponding inference is thus operated at 603. Here, the coordination drama will actuate the librarian drama according to the following rule:

If<existence of a librarian incident>=TRUE, then <actuate librarian drama>

At 604 columns relative to librarian system in the role of the incident is imported as factors for the inference. After the inference, at 605, the following inference rule is operated to determine that the student shall pay a penalty payment for the damaged book:

If <book damaged>=TRUE, then<call cashier drama later>:=TRUE and <penalty>:=<penalty>+<cost of damaged book>

After the inference, at 606, check whether other inferences shall be operated. If yes, return to step 605 where an inference is operated; Otherwise, at 607 operation of the librarian drama is completed and the operation returns to the coordination drama Subject to inferences that may be actuated, the following inference rule may exist in the coordination drama:

If <librarian role>.<call cashier drama later>—TRUE then <role of cashier drama>.<payment>:=<role of cashier drama>.<payment>+<role of librarian drama>.penalty>

and <call cashier drama>:=TRUE

As a result, at 608 this rule will be actuated, thereby in the column regarding the cashier drama of the role of the incident a penalty amount is inserted. No matter whether the cashier drama is actuated or not, this rule will actuate the cashier drama and necessary information will be exported after the inferences of the cashier drama.

When all inferences are finished, the application program will export necessary data from the role at 609 and save the data or generate an alert to the student or the relative branches at 610 for proper reactions.

### Effects of Invention

As described above, the object oriented knowledge base management system of this invention disclosed a novel expert system that relates the rule base technology to the object oriented technology. This invention simplified the management of rule bases and made it possible to establish objects to include a plurality of rules, according to their features and classifications. As a result, the establishment, development, management and inferences of rule bases are made easy.

In the present invention, the model-formatted rule base facilitates users to establish useful dramas in a easy way. The complicated processes in establishing dramas in the conventional art may thus be avoided.

In the dramas established according to the invented system, inheritance relations may be defined among roles. Management of relative data is thus made easier. In addition, inference relations may also be defined among dramas. Connections among groups of rules and groups of roles may be established and rule and data are shared. In the present invention, different dramas may be dynamically connected. System resources may thus be saved and the rule base so established may provide higher extendibility.

Under the design of this invention, all information may be encapsulated in drama objects by their classification. All dramas have their particular group of inference rules and useful information. Higher security may thus be provided.

As the present invention has been shown and described with reference to preferred embodiments thereof, those skilled in the art will recognize that the above and other changes may be made therein without departing from the spirit and scope of the invention.

What is claimed is:

1. An object oriented knowledge management system to store, manage and infer information and to output results of inferences, comprising:
a database management module, comprising
at least a drama model format rule base to store a plurality of dramas defined under a drams model format, enabling users to insert, delete and revise information contained in said dramas through a predetermined format; wherein said drama comprises;
at least one group of rules wherein each group of rules comprises a plurality of inference rules operable in a computer to obtain results of inferences; and
at least one group of roles wherein each group of roles comprises a template and contents operable by said inference rules; and
at least one database to store information including simple statements;
at least one knowledge base application software, each comprising:
a rule management module to enable users to insert, delete and revise rules stored in said drama model format rule base;
an inference management module to, upon receipt of input data or an inference result, determine actuation of particular inference rules in particular dramas and to actuate said inference rules upon said determination; and
a fact management module to convert input data into formats acceptable by said system and to define relations of said input data with selected rules and/or roles of said dramas;
a knowledge base management module to connect said at least one database application software and said database management module; and
a user interface, allowing users to insert, delete, revise and manage data in said database and roles and inference rules of said dramas;
wherein at least a drama of said drama model format rule base provides a function to actuate inference operation of at least another drama of said drama model format rule base and wherein at least one role in said dramas contains attributes existing in at least another role.

2. The object oriented knowledge base management system according to claim 1 wherein one of said dramas provides a function to determine sequence of operation of inference rules when a plurality of inference rules are actuated.

3. The object oriented knowledge base management system according to claim 1 or 2 wherein all inference rules of at least one of said dramas are included in another drama.

4. The object oriented knowledge base management system according to claim 1 or 2 wherein said inference rules comprise at least one condition and at least one operation.

5. The object oriented knowledge base management system according to claim 1 or 2 wherein said templates of roles of said dramas comprise a plurality of factors describing a role and operable by at least one inference rule.
